(19) United States
(12) Patent Application Publication
(10) Pub. No.: US 2011/0311794 A1
(43) Pub. Date: Dec. 22, 2011

(54) BIODEGRADABLE COMPLEX OXYGEN BARRIER FILM AND APPLICATION THEREOF

(76) Inventors: Qinghai Zhou, Changchun City (CN); Xianhong Wang, Changchun City (CN); Fengxiang Gao, Changchun City (CN); Xiaojiang Zhao, Changchun City (CN); Fosong Wang, Changchun City (CN); Songbao Fu, Dongfang City (CN); Keyu Chen, Dongfang City (CN); Liangliang Wang, Dongfang City (CN); Buning Chen, Dongfang City (CN); Jianbo Xu, Dongfang City (CN); Guozhong Wang, Dongfang City (CN)

(21) Appl. No.: 12/994,070

(22) PCT Filed: Jun. 19, 2009
(86) PCT No.: PCT/CN2009/000669

§ 371 Date: Aug. 18, 2011

(51) Int. Cl. B32B 7/02; B32B 27/36

(52) U.S. Cl. 428/216; 428/412

(57) ABSTRACT

The present invention discloses a biodegradable complex oxygen barrier film and its preparation method and application. The biodegradable complex oxygen barrier film disclosed by the present invention is constituted of at least two support layers and a barrier layer which is deposed between each two support layers. The support layer is selected from at least one of the following substances: polylactic acid, poly(butylene succinate), polycaprolactone, poly(adipate-butylene telephthalate), poly(β-hydroxybutyrate) and poly(β-hydroxybutyrate-valerate); the barrier layer which is deposed between the each two support layers is same or different, the barrier layer is selected from any one of the following: poly(propylene carbonate) and nano montmorillonite modified poly(propylene carbonate). The biodegradable complex oxygen barrier film of the present invention may be used as packing articles of food or medicine, helpful to prolong the guarantee period and shelf life of the foods and medicines; at the same time, white pollution could be prevented.

### TECHNICAL FIELD

The present invention relates to a biodegradable complex oxygen barrier film and its preparation method and application.

### BACKGROUND ART

Oxygen barrier packing materials are very important to prolong the guarantee period and shelf life of the foods and medicaments. It has been become a hot subject of research to intensively develop a completely biodegradable oxygen barrier film for packings because the disposable packing materials has been one of the “white pollutions”.

PVDC, EVOH, PAN, PEN, PA66, PA6 and PET generally used as barrier materials all have no biodegradable property. Although EVOH has been used largely, its water resistance property is poor: with the increasement of air humidity, the oxygen barrier property significantly decreases.

Up to now, the completely biodegradable materials developed comprise poly(butylene succinate) (PBS), polylactic acid (PLA), polycaprolactone (PCL), polyglycolic acid (PGA), poly(adipate-butylene telephthalate) (Ecoflex) and polyhydroxyalkanoate (PHA) (PLASTICS SCIENCE AND TECHNOLOGY, Lu fang, Zhu guangming, and Liu daijun, 2007, volume 35 (7), pages 92-97; POLYESTER INDUSTRY, Wang Decheng, 2008, volume 21 (3), pages 3-8) and so on. However, as known presently, the oxygen barrier property of these materials except polyhydroxyalkanoate is very poor and can not be separately used as oxygen barrier film material.

High molecular weight poly(propylene carbonate) prepared by rare earth three-component catalyst (CN1116332; CN100381480; U.S. Pat. No. 6,815,529) has both the oxygen barrier property and the biodegradable property.

Generally, the biodegradable oxygen barrier film are prepared using a method for multilayer complex film. In Chinese patent publication Nos. CN1033911 and CN10173345, the oxygen barrier film is prepared respectively by using polyvinyl alcohol and modified polyester-modified polyamide-polyvinyl alcohol as barrier layer, and polyolefin or degradable polyolefin as the support layer. In Japanese patent JP177072, the method for coating polyvinyl alcohol with >95% of degree of hydrolysis on the surface of polylactic acid film is applied to prepare the oxygen barrier film. In addition to strong water absorption, polyvinyl alcohol itself is difficult to be degraded in the natural environment, and the support layer used in Chinese patent publication Nos. CN1033911 and CN10173345 can only be decomposed into fine fragments and not be degraded by the organism, thus can not be used as biodegradable oxygen barrier film. In Chinese patent publication Nos. CN10002129 and CN10000405, a part of carbon dioxide resin is added into the barrier layer, and degradable polyolefin is used as the support layer. In patents CN0210235, JP327003, JP114657 etc., respectively, the methods of aluminizing and depositing inorganic oxide (Al₂O₃ and SiO₂) on the biodegradable films are used so as to achieve the effect of obstructing the oxygen. These methods significantly increase the production cost of the biodegradable films. Patents U.S. Pat. No. 0,069,993, WO109222, U.S. Pat. No. 0,163,944 and U.S. Pat. No. 0,184,220 respectively disclose the preparation method of biodegradable gas barrier container, the preparation method of biodegradable vapour barrier film and the preparation method of laminated sheet with oxygen barrier property, all of which are not suitable to prepare a completely biodegradable oxygen barrier film.

### DISCLOSURE OF THE INVENTION

An object of the present invention is to provide a biodegradable complex oxygen barrier film and its preparation method and application.

The biodegradable complex oxygen barrier film provided by the present invention is constituted of at least two support layers and a barrier layer deposed between each two support layers. The support layer is selected from at least one of the following substances: polylactic acid, poly(butylene succinate), polycaprolactone, poly(adipate-butylene telephthalate), poly(β-hydroxybutyrate) and poly(β-hydroxybutyrate-valerate). The barrier layer which is deposed between the each two support layers is same or different, and selected from any one of the following: poly(propylene carbonate) and nano montmorillonite modified poly(propylene carbonate).

When the support layer is selected from at least two of polylactic acid, poly(butylene succinate), polycaprolactone, poly(adipate-butylene telephthalate), poly(β-hydroxybutyrate) and poly(β-hydroxybutyrate-valerate), these two are disposed on separate layer surfaces, respectively. If the support layer is selected to use polylactic acid and poly(butylene succinate), the biodegradable complex oxygen barrier film can be constituted of polylactic acid layer, poly(butylene succinate) layer, poly(propylene carbonate) layer, poly(butylene succinate) layer and polylactic acid layer in this order, or is constituted of polylactic acid layer, poly(butylene succinate) layer, poly(propylene carbonate), polylactic acid layer and poly(butylene succinate) layer in this order.

The thickness of the biodegradable complex oxygen barrier film according to the present invention is 10-100 μm. Certainly, the thickness of the complex oxygen barrier film can also be 10-15 μm or 15-25 μm or 15-50 μm or 15-70 μm or 25-50 μm or 25-70 μm or 50-70 μm or 70-100 μm.

In the biodegradable complex oxygen barrier film described in the present invention, the thickness of the support layer is 5-25 μm; the thickness of the support layer can also be 5-10 μm or 5-15 μm or 10-15 μm or 10-25 μm or 15-25 μm. The thickness of the barrier layer is 5-20 μm, and the thickness of the barrier layer can also be 5-10 μm or 5-15 μm or 10-15 μm or 10-20 μm.

When the thicknesses of the biodegradable complex oxygen barrier film, the support layer and the barrier layer satisfy the above conditions, the biodegradable complex oxygen barrier film of the present invention can include two or three support layers, and also include more than three support layers.

Said nano montmorillonite modified poly(propylene carbonate) contains 92-99.8% poly(propylene carbonate) and 0.2-8% nano montmorillonite; preferably 95-99.5% poly(propylene carbonate) and 0.5-5% nano montmorillonite. The poly(propylene carbonate) has the number average molecular weight of 60000-200000 g/mol, and the molecular weight distribution of 2.0-7.0; preferably the number average molecular weight of 80000-150000 g/mol, and the molecular weight distribution of 2.5-5.0.

The polylactic acid has the number average molecular weight of 50000-200000 g/mol, and the molecular weight distribution of 1.5-5.0; preferably, the number average molecular weight of 80000-160000 g/mol, and the molecular weight distribution of 2.0-3.5. The poly(butylene succinate) has the number average molecular weight of 50000-200000 g/mol, and the molecular weight distribution of 1.5-6.0; preferably, the number average molecular weight of 60000-150000 g/mol, and the molecular weight distribution of 2.0-4.0. The polycaprolactone has the number average molecular weight of 80000-250000 g/mol, and the molecular weight distribution of 1.5-3.5; preferably, the number average molecular weight of 85000-200000 g/mol, and the molecular weight distribution of 1.8-2.5. The poly(adipate-butylene telephthalate) has the number average molecular weight of 30000-110000 g/mol, and the molecular weight distribution of 1.5-6.0; preferably, the number average molecular weight of 40000-90000 g/mol, and the molecular weight distribution of 2.5-4.5. The poly(β-hydroxybutyrate) has the number average molecular weight of 80000-250000 g/mol, and the molecular weight distribution of 1.0-2.5; preferably, the number average molecular weight of 90000-180000 g/mol, and the molecular weight distribution of 1.5-2.0. The poly(β-hydroxybutyrate-valerate) has the number average molecular weight of 80000-250000 g/mol, and the molecular weight distribution of 1.0-2.5; preferably, the number average molecular weight of 90000-180000 g/mol, and the molecular weight distribution is 1.5-2.0.

The biodegradable complex oxygen barrier film of the present invention could be used to prepare packing articles.

### THE BEST MODE OF CARRYING OUT THE INVENTION

The experiment methods in the following examples, unless indicated otherwise, are all routine methods.

The following percent contents, unless indicated otherwise, are all percent contents by mass.

The nano montmorillonite modified poly(propylene carbonate) used in the invention can be prepared according to the following method:

99.5 kg poly(propylene carbonate) (number average molecular weight is 80000 g/mol, molecular weight distribution is 2.5) and 0.5 kg nano montmorillonite are blended for 10 minutes in high speed mixer (1000 r/min), then the mixture is melt and blending extruded by the twin screw extruder with ratio of length to diameter of 42 at 120° C. Water strand pelletizing is adapted. After the obtained particles are dried under vacuum for 5 hours at 50° C., the nano montmorillonite modified poly(propylene carbonate) I is obtained, wherein the poly(propylene carbonate) has the number average molecular weight of 80000 g/mol, and the molecular weight distribution of 2.5, and the percent content of the nano montmorillonite is 0.5% by mass.

95 kg poly(propylene carbonate) (with number average molecular weight of 150000 g/mol, and molecular weight distribution of 5.0) and 5 kg nano montmorillonite are blended for 3 minutes in high speed mixer (1500 r/min), then the mixture is melt and blending extruded by the twin screw extruder with ratio of length to diameter of 22 at 160° C. Water pelletizing is adapted. After the obtained particles are dried under airflow for 2 hours at 70° C., the nano montmorillonite modified poly(propylene carbonate) II is obtained, wherein the poly(propylene carbonate) has the number average molecular weight of 150000 g/mol, and the molecular weight distribution of 5.0, and the percent content of the nano montmorillonite is 5% by mass.

### Example 1

### Preparation of the Biodegradable Complex Oxygen Barrier Film

1) Preparation of the Biodegradable Complex Oxygen Barrier Film I

20 kg poly(adipate-butylene telephthalate) (its number average molecular weight is 40000 g/mol, and its molecular weight distribution is 2.5), 20 kg poly(propylene carbonate) (its number average molecular weight is 80000 g/mol, and its molecular weight distribution is 2.5) and 20 kg poly(adipate-butylene telephthalate) (its number average molecular weight is 40000 g/mol, and its molecular weight distribution is 2.5) are respectively fed as outer layer, intermediate layer and inner layer into a common three-layer single screw blowing machine set. The temperatures of three sections of the inner layer and the outer layer screw are: 140° C., 160° C. and 170° C., respectively; the corresponding temperatures of the intermediate layer are: 100° C., 140° C. and 140° C.; and the temperature of the machine head is 165° C. Three extruder sets are started at the same time to prepare the biodegradable complex oxygen barrier film I. The biodegradable complex oxygen barrier film I is a complex film constituted of three layers of films, which, from bottom to top in order, are poly(adipate-butylene telephthalate) (its number average molecular weight is 40000 g/mol, and its molecular weight distribution is 2.5) layer, poly(propylene carbonate) (its number average molecular weight is 80000 g/mol, and its molecular weight distribution is 2.5) layer and poly(adipate-butylene telephthalate) (its number average molecular weight is 40000 g/mol, and its molecular weight distribution is 2.5) layer respectively. The thickness of each layer is 5 μm, and the thickness of the biodegradable complex oxygen barrier film I is 15 μm.

The tensile strength of the complex oxygen barrier film I is determined by ASTM D882-02 method; the elongation at break of the complex oxygen barrier film I is determined by ASTM D882-02 method; the oxygen permeation amount of the complex oxygen barrier film I is determined by ASTM D1434-82(2003) method; and the water vapour permeation amount of the complex oxygen barrier film I is determined by ASTM E96-05 method.

The properties of the biodegradable complex oxygen barrier film I are shown in Table 1.

2) Preparation of the Biodegradable Complex Oxygen Barrier Film II

20 kg poly(adipate-butylene telephthalate) (its number average molecular weight is 90000 g/mol, and its molecular weight distribution is 4.5), 20 kg poly(propylene carbonate) (its number average molecular weight is 150000 g/mol, and its molecular weight distribution is 5.0) and 20 kg poly(adipate-butylene telephthalate) (its number average molecular weight is 90000 g/mol, and its molecular weight distribution is 4.5) are respectively fed as outer layer, intermediate layer and inner layer into a common three-layer single screw blowing machine set. The temperatures of three sections of the inner layer and the outer layer screw are: 140° C., 160° C. and 170° C., respectively, the corresponding temperatures of the intermediate layer are: 100° C., 140° C. and 140° C., and the temperature of the machine head is 165° C. Three extruder sets are started at the same time to prepare the biodegradable complex oxygen barrier film II. The biodegradable complex oxygen barrier film II is a complex film constituted of three layers of films, which, from bottom to top in order, are poly(adipate-butylene telephthalate) (its number average molecular weight is 90000 g/mol, and its molecular weight distribution is 4.5) layer, poly(propylene carbonate) (its number average molecular weight is 150000 g/mol, and its molecular weight distribution is 5.0) layer and poly(adipate-butylene telephthalate) (its number average molecular weight is 90000 g/mol, and its molecular weight distribution is 4.5) layer, respectively. The thickness of each layer is 5 μm, and the thickness of the biodegradable complex oxygen barrier film II is 15 μm.

The properties of the biodegradable complex oxygen barrier film II are shown in Table 1.

### Example 2

### Preparation of the Biodegradable Complex Oxygen Barrier Film III

1) Preparing Biodegradable Complex Oxygen Barrier Film III

30 kg polylactic acid (PLA) (its number average molecular weight is 80000 g/mol, and its molecular weight distribution is 2.0), 30 kg nano montmorillonite modified poly(propylene carbonate) I and 15 kg poly(butylene succinate) (its number average molecular weight is 60000, and its molecular weight distribution is 2.0) are respectively fed as outer layer, intermediate layer and inner layer into a common three-layer single screw blowing machine set. The temperatures of three sections of the inner layer and the outer layer screw are: 140° C., 160° C. and 170° C., respectively, the corresponding temperatures of the intermediate layer are: 100° C., 140° C. and 140° C., and the temperature of the machine head is 165° C. Three extruder sets are started simultaneously to prepare the biodegradable complex oxygen barrier film III. The biodegradable complex oxygen barrier film III is a complex film constituted of three layers of films, which, from bottom to top in order, are polylactic acid (PLA) (its number average molecular weight is 80000 g/mol, and its molecular weight distribution is 2.0) layer, nano montmorillonite modified poly(propylene carbonate) I layer and poly(butylene succinate) (its number average molecular weight is 60000, and its molecular weight distribution is 2.0) layer, respectively. The thicknesses of each layers are 10 μm, 10 μm and 5 μm, respectively, and the thickness of the biodegradable complex oxygen barrier film III is 25 μm.

The properties of the biodegradable complex oxygen barrier film III are shown in Table 1.

2) Preparing Biodegradable Complex Oxygen Barrier Film IV

30 kg polylactic acid (PLA) (its number average molecular weight is 160000 g/mol, and its molecular weight distribution is 3.5), 30 kg nano montmorillonite modified poly(propylene carbonate) II and 15 kg poly(butylene succinate) (its number average molecular weight is 150000, and its molecular weight distribution is 4.0) are respectively fed as outer layer, intermediate layer and inner layer into a common three-layer single screw blowing machine set. The temperatures of three sections of the inner layer and the outer layer screw are: 140° C., 160° C. and 170° C., respectively, the corresponding temperatures of the intermediate layer are: 100° C., 140° C. and 140° C., respectively, and the temperature of the machine head is 165° C. Three extruder sets are started at the same time to prepare the biodegradable complex oxygen barrier film IV. The biodegradable complex oxygen barrier film IV is a complex film constituted of three layers of films, which, from bottom to top in order, are polylactic acid (PLA) (its number average molecular weight is 160000 g/mol, and its molecular weight distribution is 3.5) layer, nano montmorillonite modified poly(propylene carbonate) II layer and poly(butylene succinate) (its number average molecular weight is 150000, and its molecular weight distribution is 4.0) layer, respectively. The thicknesses of each layers are 10 μm, 10 μm and 5 μm, respectively, and the thickness of the biodegradable complex oxygen barrier film IV is 25 μm.

The properties of the biodegradable complex oxygen barrier film IV are shown in Table 1.

### Example 3

### Preparation of Biodegradable Complex Oxygen Barrier Film

1) Preparing Biodegradable Complex Oxygen Barrier Film V

20 kg poly(butylene succinate) (its number average molecular weight is 60000, and its molecular weight distribution is 2.0), 10 kg polycaprolactone(its number average molecular weight is 85000, and its molecular weight distribution is 1.8), 40 kg poly(propylene carbonate) (its number average molecular weight is 80000 g/mol, and its molecular weight distribution is 2.5), 10 kg polycaprolactone (its number average molecular weight is 85000, and its molecular weight distribution is 1.8) and 20 kg poly(butylene succinate) (its number average molecular weight is 60000, and its molecular weight distribution is 2.0) are respectively fed in this order from outer to inner into a five-layer single screw co-extrusion blowing machine set, wherein the temperatures of three sections of the screw of material poly(butylene succinate) are: 140° C., 160° C. and 170° C., respectively, the temperatures of three sections of the screw of material polycaprolactone are: 100° C., 170° C. and 190° C., respectively, the temperatures of three sections of the screw of material poly(propylene carbonate) are: 110° C., 140° C. and 140° C., respectively, and the temperature of the machine head is 175° C. Five extruder sets are started at the same time to prepare the biodegradable complex oxygen barrier film V. The biodegradable complex oxygen barrier film V is a complex film constituted of five layers of films, which, from bottom to top in order, are poly(butylene succinate) (its number average molecular weight is 60000, and its molecular weight distribution is 2.0) layer, polycaprolactone (its number average molecular weight is 85000, and its molecular weight distribution is 1.8) layer, poly(propylene carbonate) (its number average molecular weight is 80000 g/mol, and its molecular weight distribution is 2.5) layer, polycaprolactone (its number average molecular weight is 85000, and its molecular weight distribution is 1.8) layer and poly(butylene succinate) (its number average molecular weight is 60000, and its molecular weight distribution is 2.0) layer, respectively. The thicknesses of each layers are 10 μm, 5 μm, 20 μm, 5 μm and 10 μm, respectively, and the thickness of the biodegradable complex oxygen barrier film V is 50 μm.

The properties of the biodegradable complex oxygen barrier film V are shown in Table 1.

2) Preparing Biodegradable Complex Oxygen Barrier Film VI

20 kg poly(butylene succinate) (its number average molecular weight is 150000, and its molecular weight distribution is 4.0), 10 kg polycaprolactone (its number average molecular weight is 200000, and its molecular weight distribution is 2.5), 40 kg poly(propylene carbonate) (its number average molecular weight is 150000 g/mol, and its molecular weight distribution is 5.0), 10 kg polycaprolactone (its number average molecular weight is 200000, and its molecular weight distribution is 2.5) and 20 kg poly(butylene succinate) (its number average molecular weight is 150000, and its molecular weight distribution is 4.0) are respectively fed in this order from outer to inner into a five-layer single screw co-extrusion blowing machine set, wherein the temperatures of three sections of the screw of material poly(butylene succinate) are: 140° C., 160° C. and 170° C., respectively, the temperatures of three sections of the screw of material polycaprolactone are: 100° C., 170° C. and 190° C., respectively, the temperatures of three sections of the screw of material poly(propylene carbonate) are: 110° C., 140° C. and 140° C., respectively, and the temperature of the machine head is 175° C. Five extruder sets are started at the same time to prepare the biodegradable complex oxygen barrier film VI. The biodegradable complex oxygen barrier film VI is a complex film constituted of five layers of films, which, from bottom to top in order, are poly(butylene succinate) (its number average molecular weight is 150000, and its molecular weight distribution is 4.0) layer, polycaprolactone (its number average molecular weight is 200000, and its molecular weight distribution is 2.5) layer, poly(propylene carbonate) (its number average molecular weight is 150000 g/mol, and its molecular weight distribution is 5.0) layer, polycaprolactone (its number average molecular weight is 200000, and its molecular weight distribution is 2.5) layer and poly(butylene succinate) (its number average molecular weight is 150000, and its molecular weight distribution is 4.0) layer, respectively. The thicknesses of each layers are 10 μm, 5 μm, 20 μm, 5 μm and 10 μm, respectively, and the thickness of the biodegradable complex oxygen barrier film VI is 50 μm.

The properties of the biodegradable complex oxygen barrier film VI are shown in Table 1.

### Example 4

### Preparation of the Biodegradable Complex Oxygen Barrier Film

1) Preparing Biodegradable Complex Oxygen Barrier Film VII

20 kg poly(adipate-butylene telephthalate) (its number average molecular weight is 40000 g/mol, and its molecular weight distribution is 2.5), 5 kg polycaprolactone (its number average molecular weight is 85000, and its molecular weight distribution is 1.8), 20 kg poly(propylene carbonate) (its number average molecular weight is 80000 g/mol, and its molecular weight distribution is 2.5), 5 kg polycaprolactone (its number average molecular weight is 85000, and its molecular weight distribution is 1.8) and 20 kg poly(adipate-butylene telephthalate) (its number average molecular weight is 40000 g/mol, and its molecular weight distribution is 2.5) are respectively fed in this order from outer to inner into a five-layer single screw co-extrusion blowing machine set, wherein the temperatures of three sections of the screw of material poly(adipate-butylene telephthalate) are: 140° C., 160° C. and 170° C., respectively, the temperatures of three sections of the screw of material polycaprolactone are: 100° C., 170° C. and 190° C., respectively, the temperatures of three sections of the screw of material poly(propylene carbonate) are: 110° C., 140° C. and 140° C., respectively, and the temperature of the machine head is 175° C. Five extruder sets are started at the same time to prepare the biodegradable complex oxygen barrier film VII. The biodegradable complex oxygen barrier film VII is a complex film constituted of five layers of films, which, from bottom to top in order, are poly(adipate-butylene telephthalate) (its number average molecular weight is 40000 g/mol, and its molecular weight distribution is 2.5) layer, polycaprolactone (its number average molecular weight is 85000, and its molecular weight distribution is 1.8) layer, poly(propylene carbonate) (its number average molecular weight is 80000 g/mol, and its molecular weight distribution is 2.5) layer, polycaprolactone (its number average molecular weight is 85000, and its molecular weight distribution is 1.8) layer and poly(adipate-butylene telephthalate) (its number average molecular weight is 40000 g/mol, and its molecular weight distribution is 2.5) layer, respectively. The thicknesses of each layers are 20 μm, 5 μm, 20 μm, 5 μm and 20 μm, respectively, and the thickness of the biodegradable complex oxygen barrier film VII is 70 μm.

The properties of the biodegradable complex oxygen barrier film VII are shown in Table 1.

2) Preparing Biodegradable Complex Oxygen Barrier Film VIII

20 kg poly(adipate-butylene telephthalate) (its number average molecular weight is 90000 g/mol, and its molecular weight distribution is 4.5), 5 kg polycaprolactone (its number average molecular weight is 200000, and its molecular weight distribution is 2.5), 20 kg poly(propylene carbonate) (its number average molecular weight is 150000 g/mol, and its molecular weight distribution is 5.0), 5 kg polycaprolactone (its number average molecular weight is 200000, and its molecular weight distribution is 2.5) and 20 kg poly(adipate-butylene telephthalate) (its number average molecular weight is 90000 g/mol, and its molecular weight distribution is 4.5) are respectively fed in this order from outer to inner into a five-layer single screw co-extrusion blowing machine set, wherein the temperatures of three sections of the screw of material poly(adipate-butylene telephthalate) are: 140° C., 160° C. and 170° C., respectively, the temperatures of three sections of the screw of material polycaprolactone are: 100° C., 170° C. and 190° C., respectively, the temperatures of three sections of the screw of material poly(propylene carbonate) are: 110° C., 140° C. and 140° C., respectively, and the temperature of the machine head is 175° C. Five extruder sets are started at the same time to prepare the biodegradable complex oxygen barrier film VIII. The biodegradable complex oxygen barrier film VIII is a complex film constituted of five layers of films, which, from bottom to top in order, are poly(adipate-butylene telephthalate) (its number average molecular weight is 90000 g/mol, and its molecular weight distribution is 4.5) layer, polycaprolactone (its number average molecular weight is 200000, and its molecular weight distribution is 2.5) layer, poly(propylene carbonate) (its number average molecular weight is 150000 g/mol, and its molecular weight distribution is 5.0) layer, polycaprolactone (its number average molecular weight is 200000, and its molecular weight distribution is 2.5) layer and poly(adipate-butylene telephthalate) (its number average molecular weight is 90000 g/mol, and its molecular weight distribution is 4.5) layer, respectively. The thicknesses of each layers are 20 μm, 5 μm, 20 μm, 5 μm and 20 μm, respectively, and the thickness of the biodegradable complex oxygen barrier film VIII is 70 μm.

The properties of the biodegradable complex oxygen barrier film VIII are shown in Table 1.

### Example 5

### Preparation of the Complex Oxygen Barrier Film

1) Preparing Biodegradable Complex Oxygen Barrier Film IX

20 kg poly(butylene succinate) (its number average molecular weight is 150000, and its molecular weight distribution is 4.0), 20 kg poly(β-hydroxybutyrate-valerate) (its number average molecular weight is 180000, and its molecular weight distribution is 2.0), 20 kg nano montmorillonite modified poly(propylene carbonate) I, 20 kg poly(β-hydroxybutyrate) (its number average molecular weight is 180000, and its molecular weight distribution is 2.0) and 20 kg poly(adipate-butylene telephthalate) (its number average molecular weight is 90000 g/mol, and its molecular weight distribution is 4.5) are respectively fed in this order from outer to inner into a five-layer single screw co-extrusion blowing machine set, wherein the temperatures of three sections of the screw of material poly(adipate-butylene telephthalate) and poly(butylene succinate) are: 140° C., 160° C. and 170° C., respectively, the temperatures of three sections of the screw of material poly(β-hydroxybutyrate-valerate) are: 140° C., 170° C. and 190° C., respectively, the temperatures of three sections of the screw of material nano montmorillonite modified poly(propylene carbonate) I are: 110° C., 140° C. and 140° C., respectively, and the temperature of the machine head is 175° C. Five extruder sets are started at the same time to prepare the biodegradable complex oxygen barrier film IX. The biodegradable complex oxygen barrier film IX is a complex film constituted of five layers of films, which, from bottom to top in order, are poly(butylene succinate) (its number average molecular weight is 150000, and its molecular weight distribution is 4.0) layer, poly(β-hydroxybutyrate-valerate) (its number average molecular weight is 180000, and its molecular weight distribution is 2.0) layer, nano montmorillonite modified poly(propylene carbonate) I layer, poly(β-hydroxybutyrate) (its number average molecular weight is 180000, and its molecular weight distribution is 2.0) layer and poly(adipate-butylene telephthalate) (its number average molecular weight is 90000 g/mol, and its molecular weight distribution is 4.5) layer respectively. The thickness of each layer is 5 μm, and the thickness of the biodegradable complex oxygen barrier film IX is 25 μm.

The properties of the biodegradable complex oxygen barrier film IX are shown in Table 1.

2) Preparing Biodegradable Complex Oxygen Barrier Film X

20 kg poly(butylene succinate) (its number average molecular weight is 60000, and its molecular weight distribution is 2.0), 20 kg poly(β-hydroxybutyrate-valerate) (its number average molecular weight is 90000, and its molecular weight distribution is 1.5), 20 kg nano montmorillonite modified poly(propylene carbonate) I, 20 kg poly(β-hydroxybutyrate) (its number average molecular weight is 190000, and its molecular weight distribution is 1.5) and 20 kg poly(adipate-butylene telephthalate) (its number average molecular weight is 40000 g/mol, and its molecular weight distribution is 2.5) are respectively fed in this order from outer to inner into a five-layer single screw co-extrusion blowing machine set, wherein the temperatures of three sections of the screw of material poly(adipate-butylene telephthalate) and poly(butylene succinate) are: 140° C., 160° C. and 170° C., respectively, the temperatures of three sections of the screw of material poly(β-hydroxybutyrate-valerate) are: 140° C., 170° C. and 190° C., respectively, the temperatures of three sections of the screw of material nano montmorillonite modified poly(propylene carbonate) I are: 110° C., 140° C. and 140° C., respectively, and the temperature of the machine head is 175° C. Five extruder sets are started at the same time to prepare the biodegradable complex oxygen barrier film X. The biodegradable complex oxygen barrier film X is a complex film constituted of five layers of films, which, from bottom to top in order, are poly(butylene succinate) (its number average molecular weight is 60000, and its molecular weight distribution is 2.0) layer, poly(β-hydroxybutyrate-valerate) (its number average molecular weight is 90000, and its molecular weight distribution is 1.5) layer, nano montmorillonite modified poly(propylene carbonate) I layer, poly(β-hydroxybutyrate) (its number average molecular weight is 190000, and its molecular weight distribution is 1.5) layer and poly(adipate-butylene telephthalate) (its number average molecular weight is 40000 g/mol, and its molecular weight distribution is 2.5) layer, respectively. The thickness of each layer is 5 μm, and the thickness of the biodegradable complex oxygen barrier film X is 25 μm.

The properties of the biodegradable complex oxygen barrier film X are shown in Table 1.

### Example 6

### Preparation of the Biodegradable Complex Oxygen Barrier Film

1) Preparing Biodegradable Complex Oxygen Barrier Film XI

20 kg poly(adipate-butylene telephthalate) (its number average molecular weight is 40000 g/mol, and its molecular weight distribution is 2.5), 40 kg nano montmorillonite modified poly(propylene carbonate) I, 20 kg polycaprolactone (its number average molecular weight is 85000, and its molecular weight distribution is 1.8), 40 kg poly(propylene carbonate) (its number average molecular weight is 80000 g/mol, and its molecular weight distribution is 2.5) and 20 kg poly(butylene succinate) (its number average molecular weight is 60000, and its molecular weight distribution is 2.0) are respectively fed in this order from outer to inner into a five-layer single screw co-extrusion blowing machine set, wherein the temperatures of three sections of the screw of material poly(adipate-butylene telephthalate) and poly(butylene succinate) are: 140° C., 160° C. and 170° C., respectively, the temperatures of three sections of the screw of material polycaprolactone are: 140° C., 170° C. and 190° C., respectively, the temperatures of three sections of the screw of material poly(propylene carbonate) and nano montmorillonite modified poly(propylene carbonate) I are: 110° C., 140° C. and 140° C., respectively, and the temperature of the machine head is 175° C. Five extruder sets are started at the same time to prepare the biodegradable complex oxygen barrier film XI. The biodegradable complex oxygen barrier film XI is a complex film constituted of five layers of films, which, from bottom to top in order, are poly(adipate-butylene telephthalate) (its number average molecular weight is 40000 g/mol, and its molecular weight distribution is 2.5) layer, nano montmorillonite modified poly(propylene carbonate) I layer, polycaprolactone(its number average molecular weight is 85000, and its molecular weight distribution is 1.8) layer, poly(propylene carbonate) (its number average molecular weight is 80000 g/mol, and its molecular weight distribution is 2.5) layer and poly(butylene succinate) (its number average molecular weight is 60000, and its molecular weight distribution is 2.0) layer, respectively. The thicknesses of each layers are 10 μm, 20 μm, 10 μm, 20 μm and 10 μm, respectively, and the thickness of the biodegradable complex oxygen barrier film XI is 70 μm.

The properties of the biodegradable complex oxygen barrier film XI are shown in Table 1.

2) Preparing Biodegradable Complex Oxygen Barrier Film XII

20 kg poly(adipate-butylene telephthalate) (its number average molecular weight is 90000 g/mol, and its molecular weight distribution is 4.5), 40 kg nano montmorillonite modified poly(propylene carbonate) II, 20 kg polycaprolactone (its number average molecular weight is 200000, and its molecular weight distribution is 2.5), 40 kg poly(propylene carbonate) (its number average molecular weight is 150000 g/mol, and its molecular weight distribution is 5.0) and 20 kg poly(butylene succinate) (its number average molecular weight is 150000, and its molecular weight distribution is 4.0) are respectively fed in this order from outer to inner into a five-layer single screw co-extrusion blowing machine set, wherein the temperatures of three sections of the screw of material poly(adipate-butylene telephthalate) and poly(butylene succinate) are: 140° C., 160° C. and 170° C., respectively, the temperatures of three sections of the screw of material polycaprolactone are: 140° C., 170° C. and 190° C., respectively, the temperatures of three sections of the screw of material poly(propylene carbonate) and nano montmorillonite modified poly(propylene carbonate) I are: 110° C., 140° C. and 140° C., respectively, and the temperature of the machine head is 175° C. Five extruder sets are started at the same time to prepare the biodegradable complex oxygen barrier film XII. The biodegradable complex oxygen barrier film XII is a complex film constituted of five layers of films, which, from bottom to top in order, are poly(adipate-butylene telephthalate) (its number average molecular weight is 90000 g/mol, and its molecular weight distribution is 4.5) layer, nano montmorillonite modified poly(propylene carbonate) II layer, polycaprolactone (its number average molecular weight is 200000, and its molecular weight distribution is 2.5) layer, poly(propylene carbonate) (its number average molecular weight is 150000 g/mol, and its molecular weight distribution is 5.0) layer and poly(butylene succinate) (its number average molecular weight is 150000, and its molecular weight distribution is 4.0) layer, respectively. The thicknesses of each layers are 10 μm, 20 μm and 10 μm, respectively, and the thickness of the biodegradable complex oxygen barrier film XII is 70 μm.

The properties of the biodegradable complex oxygen barrier film XII are shown in Table 1.

TABLE 1
The properties of the biodegradable complex oxygen barrier films

| | | | | Oxygen | Water |
|---|---|---|---|---|---|
| | | | Elongation | permeation | vapour |
| | | Tensile | at | amount | permeation |
| | | strength | break | (cm³/m² | amount |
| | | (Mpa) | (%) | d atm) | (g/m²d) |
| biodegradable | lengthways | 41 | 370 | 29.7 | 306 |
| complex oxygen | transverse | 33 | 430 | | |
| barrier film I | | | | | |
| biodegradable | lengthways | 42 | 380 | 28.6 | 298 |
| complex oxygen | transverse | 33 | 440 | | |
| barrier film II | | | | | |
| biodegradable | lengthways | 33 | 140 | 21.3 | 150 |
| complex oxygen | transverse | 28 | 190 | | |
| barrier film III | | | | | |
| biodegradable | lengthways | 32 | 120 | 27.7 | 210 |
| complex oxygen | transverse | 25 | 180 | | |
| barrier film IV | | | | | |
| biodegradable | lengthways | 39 | 420 | 28.6 | 270 |
| complex oxygen | transverse | 35 | 470 | | |
| barrier film V | | | | | |
| biodegradable | lengthways | 41 | 400 | 26.4 | 250 |
| complex oxygen | transverse | 37 | 480 | | |
| barrier film VI | | | | | |
| biodegradable | lengthways | 47 | 90 | 26.3 | 410 |
| complex oxygen | transverse | 42 | 140 | | |
| barrier film VII | | | | | |
| biodegradable | lengthways | 46 | 110 | 25.2 | 395 |
| complex oxygen | transverse | 43 | 140 | | |
| barrier film VIII | | | | | |
| biodegradable | lengthways | 28 | 130 | 28.4 | 350 |
| complex oxygen | transverse | 23 | 160 | | |
| barrier film IX | | | | | |
| biodegradable | lengthways | 28 | 140 | 28.2 | 330 |
| complex oxygen | transverse | 22 | 170 | | |
| barrier film X | | | | | |
| biodegradable | lengthways | 37 | 230 | 17.8 | 135 |
| complex oxygen | transverse | 34 | 290 | | |
| barrier film XI | | | | | |
| biodegradable | lengthways | 36 | 210 | 19.1 | 150 |
| complex oxygen | transverse | 30 | 290 | | |
| barrier film XII | | | | | |

### INDUSTRY APPLICATION

The biodegradable complex oxygen barrier film of the present invention uses biodegradable polyester as support layer, biodegradable poly(propylene carbonate) or nano montmorillonite modified poly(propylene carbonate) as oxygen barrier layer. The oxygen permeation amount thereof can be up to 25.4 cm³/m²·d·atm averagely, minimum value is 17.8 m³/m²·d·atm, which is comparable to PEN or PA66, and superior to PET, belonging to middle or high class of oxygen barrier film; its water vapour permeation amount is near to that of PA6 with an average value of 269 g/m²·d, and a minimum value of 135 g/m²·d. The physical and mechanical properties of the biodegradable complex oxygen barrier film of the present invention is completely consistent with or slight higher than that of the existing biodegradable film (poor oxygen barrier property). The biodegradable complex oxygen barrier film of the present invention may be used as packing articles of food or drugs, helpful to prolong the guarantee period and shelf life of the foods, medicines and the like; at the same time, white pollution could be prevented.

1. An oxygen barrier film, which is constituted of at least two support layers and a barrier layer deposed between each two support layers, the support layers comprise a substance selected from at least one of the following substances: polylactic acid, poly(butylene succinate), polycaprolactone, poly(adipate-butylene telephthalate), poly(β-hydroxybutyrate) and poly(β-hydroxybutyrate-valerate); the barrier layer which is deposed between the each two support layers is same or different, the barrier layer comprise a material selected from any one of the following: poly(propylene carbonate) and nano montmorillonite modified poly(propylene carbonate).

2. The oxygen barrier film of claim 1, characterized in that: the support layers comprise a material selected from at least two of polylactic acid, poly(butylene succinate), polycaprolactone, poly(adipate-butylene telephthalate), poly(β-hydroxybutyrate) and poly(β-hydroxybutyrate-valerate), which are disposed on separate layer surfaces, respectively.

3. The oxygen barrier film of claim 1, characterized in that: the complex oxygen barrier film include two or three support layers.

4. The oxygen barrier film of claim 1, characterized in that: the nano montmorillonite modified poly(propylene carbonate) is constituted of 92-99.8% (by mass) poly(propylene carbonate) and 0.2-8% (by mass) nano montmorillonite.

5. The oxygen barrier film of claim 4, characterized in that: the nano montmorillonite modified poly(propylene carbonate) is constituted of 95-99.5% (by mass) poly(propylene carbonate) and 0.5-5% (by mass) nano montmorillonite.

6. The oxygen barrier film of claim 1, characterized in that: the poly(propylene carbonate) has the number average molecular weight of 60000-200000 g/mol, and the molecular weight distribution of 2.0-7.0.

7. The oxygen barrier film of claim 6, characterized in that: the poly(propylene carbonate) has the number average molecular weight of 80000-150000 g/mol, and the molecular weight distribution of 2.5-5.0.

8. The oxygen barrier film of claim 1, characterized in that: the polylactic acid has the number average molecular weight of 50000-200000 g/mol, and the molecular weight distribution of 1.5-5.0.

9. The oxygen barrier film of claim 8, characterized in that: the polylactic acid has the number average molecular weight of 80000-160000 g/mol, and the molecular weight distribution of 2.0-3.5.

10. The oxygen barrier film of claim 1, characterized in that: the poly(butylene succinate) has the number average molecular weight of 50000-200000 g/mol, and the molecular weight distribution of 1.5-6.0.

11. The oxygen barrier film of claim 10, characterized in that: the poly(butylene succinate) has the number average molecular weight of 60000-150000 g/mol, and the molecular weight distribution of 2.0-4.0.

12. The oxygen barrier film of claim 1, characterized in that: the polycaprolactone has the number average molecular weight of 80000-250000 g/mol, and the molecular weight distribution of 1.5-3.5.

13. The oxygen barrier film of claim 12, characterized in that: the polycaprolactone has the number average molecular weight of 85000-200000 g/mol, and the molecular weight distribution of 1.8-2.5.

14. The oxygen barrier film of claim 1, characterized in that: the poly(adipate-butylene telephthalate) has the number average molecular weight of 30000-110000 g/mol, and the molecular weight distribution of 1.5-6.0.

15. The oxygen barrier film of claim 14, characterized in that: the poly(adipate-butylene telephthalate) has the number average molecular weight of 40000-90000 g/mol, and the molecular weight distribution of 2.5-4.5.

16. The oxygen barrier film of claim 1, characterized in that: the poly(β-hydroxybutyrate) has the number average molecular weight of 80000-250000 g/mol, and the molecular weight distribution of 1.0-2.5.

17. The oxygen barrier film of claim 14, characterized in that: the poly(β-hydroxybutyrate) has the number average molecular weight of 90000-180000 g/mol, and the molecular weight distribution of 1.5-2.0.

18. The oxygen barrier film of claim 1, characterized in that: the polyβ-hydroxybutyrate-valerate) has the number average molecular weight of 80000-250000 g/mol, and the molecular weight distribution of 1.0-2.5.

19. The oxygen barrier film of claim 18, characterized in that: the poly(β-hydroxybutyrate-valerate) has the number average molecular weight of 90000-180000 g/mol, and the molecular weight distribution of 1.5-2.0.

20. The oxygen barrier film of claim 1, characterized in that: the thickness of each of the support layers is 5-25 μm.

21. The oxygen barrier film of claim 20, characterized in that: the thickness of each of the support layers is 5-10 μm or 5-15 μm or 10-15 μm or 10-25 μm or 15-25 μm.

22. The oxygen barrier film of claim 1, characterized in that: the thickness of the barrier layer is 5-20 μm.

23. The oxygen barrier film of claim 22, characterized in that: the thickness of the barrier layer is 5-10 μm or 5-15 μm or 10-15 μm or 10-20 μm or 15-20 μm.

24. The oxygen barrier film of claim 1, characterized in that: the thickness of the oxygen barrier film is 10-100 μm.

25. The oxygen barrier film of claim 24, characterized in that: the thickness of the complex oxygen barrier film is 10-15 μm or 15-25 μm or 15-50 μm or 15-70 μm or 25-50 μm or 25-70 μm or 50-70 μm or 70-100 μm or 50-100 μm.

26. The oxygen barrier film of claim 1, wherein the oxygen barrier film is configured to be utilized in preparing packing articles.
